(19) United States
(12) Patent Application Publication
(10) Pub. No.: US 2010/0282399 A1
(43) Pub. Date: Nov. 11, 2010

(54) Filament based open celled carrier web system for pressure sensitive product assemblies

(75) Inventor: Jesse D. Crum, Fort scott, KS (US)

Correspondence Address: Ward/Kraft, Inc.;Attn: Ray Russell, 2401 Cooper Street, P.O. Box 938, Fort Scott, KS, 66701, US

(73) Assignee: Ward/Kraft., Inc.

(21) Appl. No.: 12/804,246

(22) Filed: Jul. 16, 2010

Related U.S. Application Data
(62) Division of application No. 11/190,346, filed on Jul. 26, 2005.

(51) Int. Cl. G09F 3/02; B32B 37/02

(52) U.S. Cl. 156/166

(57) ABSTRACT

The present invention relates to the use of an open carrier web, a web having a series of regularly occurring openings or spaces that is used in connection with pressure sensitive products, namely labels. The carrier web uses a series of strings or filaments that are spaced from one another and travel in one or more directions depending on the particular configuration of the web that is being used. The open lattice work of the carrier web permits areas of the adhesive to be exposed while at the same time provides enough distance between successive layers of the pressure sensitive products that the adhesive will not cause the layers to become permanently adhered together. The carrier web assembly may be used in connection with continuous pressure sensitive products, that is where the web consists of a single continuous substrate, or alternatively, with a number of discrete individual labels that may be carried on the web.

### CROSS-REFERENCES TO RELATED APPLICATIONS

None.

### FIELD OF THE INVENTION

The present invention is found in the field of liner or carrier systems that are utilized in moving or handling adhesive backed substrates, such as labels, through processing and handling apparatus. More particularly the instant invention is directed toward the development of an inexpensive carrier web that is easy to produce and which may be used with individual labels and other pressure sensitive laminates, in a shingled or slightly overlapping arrangement. The carrier web utilizes a series of cooperating filaments, strands or strings that forms an open web construction or honeycomb type of configuration that may function or serve as a removable liner for a series of discrete pressure sensitive label and laminate assemblies that are placed on the carrier web. The filaments, strings or strands are placed in a predetermined relationship so that they traverse each other in a series of at least two distinct directions.

### BACKGROUND OF THE INVENTION

Conventional pressure sensitive assemblies normally include a substrate having on one side a coating of adhesive, that is normally tacky to the touch, and a release liner disposed in a facial relationship with the adhesive to prevent the adhesive from coming into contact with the various processing surfaces of the apparatus that is handling the web of pressure sensitive material. The liner material will typically consist of a highly calendared stock to which a layer of silicone has been applied to one side of the stock. In use, the liner material is stripped away from the pressure sensitive adhesive assembly and is normally discarded. The adhesive will remain with the substrate to which it was originally applied as the adhesive has a greater affinity for the label substrate or sheets than for the carrier web or liner material as the label segments do not have a release coating applied to the surface in contact with the adhesive.

Discarding of the carrier web or liner material has always been looked on as being wasteful as normally the liner material simply finds its way to the local landfill. In addition, in certain jurisdictions, additional fees may accompany the disposal of such materials as the materials cannot generally be recycled due to the silicone coating resident on the liner or carrier web of material.

Such environmental concerns lead to the rise of “linerless” pressure sensitive products in which a substrate was coated on one side with a silicone or other release material and on the other or opposite side with a pressure sensitive adhesive. This “all in one” type arrangement then permitted the web of labels to be wound onto itself and then unwound for application. The silicone coating on the one surface thereby allowing the adhesive to be unwound from the roll of material.

There were however certain problems associated with such linerless constructions. Initially, if the silicone layer is not adequately secured to the substrate, the silicone will peel off when the web is unwound as the adhesive pulls the release material off the substrate. This can have the effect of blocking the adhesive and preventing the label from sticking to the intended surface.

The silicone covering can also make printing or imaging over the silicone difficult as the ink or toner may be prevented from being fully adhered to the surface thus permitting the imaging or printing to become smudged or smeared on contact. Alternatively, if the toner or ink does not bond at all with the surface the entire image or print may be wiped completely away from the surface on which it had been printed.

A further drawback associated with linerless technology is that the printers and label applicators that were used in label applying applications had to be retrofitted with special surfaces. This is due to the situation when the linerless label was unwound and the adhesive exposed, the adhesive on the linerless label would stick to any exposed surface in the application process. Such a situation, if left unresolved, would likely lead to jamming and clogging of the apparatus, thereby potentially slowing if not shutting down the label application process. Thus, it became necessary to treat parts of the apparatus with a high release material so that the exposed adhesive would not stick to the surface of the apparatus. This, as expected, would increase the cost to the user of such products as the user would have to treat or acquire parts having such a high release coating in order to use linerless technology. The cost as well as the inconvenience of having to either make such retrofits or alternatively acquire new machinery further frustrated the acceptance of linerless technology.

Linerless solutions, while seeming to solve the environmental concerns addressed above were also more expensive to manufacture than conventional linered products. Thus, while potential users realized the possible environmental friendliness of the construction, the additional cost associated with the linerless product was simply too much for most users of traditional linered pressure sensitive products to switch to the linerless solutions.

What is needed therefore is an economical system to deliver a pressure sensitive product and which does not suffer from the foregoing drawbacks.

### BRIEF SUMMARY OF THE INVENTION

The embodiments of the present invention described below are not intended to be exhaustive or to limit the invention to the precise forms disclosed in the following detailed description. Rather, the embodiments are chosen and described so that others skilled in the art may appreciate and understand the principles and practices of the present invention.

Unexpectedly, it has been discovered that through the use of filaments, strands or strings bonded together in a loose lattice work, such as a honeycomb pattern or grid like arrangement, an effective and economical system can be created to carrier pressure sensitive products through various processing steps such as printing, die cutting, application and the like. The filaments or strings that are used to make up the lattice matrix may have imparted to them a release property, such as that found when using silicone based materials, such that the adhesive on the pressure sensitive product will readily release from the carrier matrix and remain with the pressure sensitive label or other laminate.

The loose matrix or lattice web used in connection with the present invention can then be collected, such as by winding for reuse, discarded, although a less preferable option the lattice work carrier web represents a smaller amount of material to be placed in the landfill, or alternatively, used for other purposes such as in webs for landscaping mats and erosion control.

In one exemplary embodiment of the present invention, a filament based carrier web system for pressure sensitive products is described and includes a substrate that has first and second faces and a pattern of adhesive applied to the second face of the substrate. The substrate has a width and a length and the substrate is divided into a series of discrete individual segments with each segment containing indicia and adhesive on faces opposite one another. A carrier web that is composed of at least two continuous filaments are disposed substantially parallel to and spaced from each other and with each of the filaments running generally in a first direction. The carrier web further includes a series of regularly occurring strands spaced from one another and running generally in a second direction distinct from the first direction.

The continuous filaments and the regularly occurring strands form regularly occurring spaces in the carrier web such that a regular pattern of portions of the pattern of adhesive on each of the segments are not covered by the carrier web.

In a further exemplary embodiment of the present invention, a pressure sensitive product that has an open carrier web disposed thereon, is described and includes a substrate that has first and second surfaces, first and second transversely extending edges and first and second longitudinally extending sides and a first length and width. The substrate is divided into a number of discrete label segments. A pattern of pressure sensitive adhesive is disposed on the second surface of the substrate such that the pattern of pressure sensitive adhesive is on each of the discrete label segments.

The presently described embodiment includes a carrier web that is constructed from a first series of filaments that are disposed substantially parallel to and spaced equally apart from one another and run in a first direction. A second series of filaments are used and are disposed substantially parallel to and spaced equally apart from one another and run in a second direction distinct from the first direction. The first series of filaments traverses the second series of filaments and are bonded thereto to form an open carrier web assembly that has a plurality regularly occurring open cells. The open carrier web is placed in direct contact with the pattern of adhesive on the each of the discrete label segments so that exposed adhesive is visible in each of the regularly occurring open cells of the web.

In a yet still further exemplary embodiment of the present invention, a pressure sensitive intermediate assembly is described and includes a carrier web that has at least a first set of strings that are substantially, equally spaced from one another and have a gap between each of the strings. The set of strings extends in a first direction and has a first length.

A series of pressure sensitive label intermediates are provided in connection with the presently described embodiment with each of the intermediates having first and second faces, first and second longitudinally extending sides and first and second transversely extending edges. Each of the intermediates has a length that is less than the length of the set of strings. Each of the label intermediates is also provided with high quality printing that is applied to at least the first face and a pattern of adhesive applied to second face.

The series of pressure sensitive label intermediates are placed individually on the carrier web in a regularly occurring sequence to form a pressure sensitive intermediate assembly that has a number of discrete, individual label segments unconnected to one another.

The open carrier web structure may be formed so that the individual openings in the web are substantially quadrate or non-quadrate, e.g. hexagonal, round, triangular, etc. depending on the particular needs of the user or alternatively aesthetics or available configuration of the materials that are used in forming the pressure sensitive products. For example, a pressure sensitive product that uses a relatively thick coating of adhesive and which has a fairly aggressive bonding level may require a web that has smaller openings whereas a pressure sensitive product that is provided with a removable or repositionable adhesive may utilize a carrier web having larger openings due to the reduced tackiness or bonding strength of the adhesive and the likelihood that the adhesive will become glued or adhered to the surface of any subsequent layers of pressure sensitive products.

The filaments, strings or strands that are used to make the open carrier web structure of the present invention may include first and second sets of filaments that are positioned in two directions from one another. For example, to produce a structure in which a number of quadrate openings in the web, the first set of filaments may run along an “X” axis and a second set of filaments may run substantially perpendicular to the first set and along the “Y” axis. In forming other shapes of the openings, the first set of filaments may run along the “X” axis and the second set of filaments may run at an angle thereto creating other geometric configurations. In addition, third, fourth, fifth, etc. groups of filaments may be used to form the open lattice work that is used in creating the carrier web structure.

These and other objects of the invention will become clear from an inspection of the detailed description of the invention and from the appended claims.

### BRIEF DESCRIPTION OF THE DRAWINGS

These, as well as other objects and advantages of this invention, will be more completely understood and appreciated by referring to the following more detailed description of the presently preferred exemplary embodiments of the invention in conjunction with the accompanying drawings, of which:

FIG. 1 depicts a view of a quadrate, open cell structure of the carrier web of the present invention having areas of exposed adhesive;

FIG. 2 shows an alternate view of the open cell structure of the carrier web of the present invention showing a non-quadrate or honeycomb type of arrangement having areas of exposed adhesive;

FIG. 3 presents a side view of an exemplary pressure sensitive configuration produced in accordance with the present invention and showing the carrier web, adhesive layer and product layer; and

FIG. 4 illustrates a schematic of an exemplary apparatus used in manufacturing the pressure sensitive products produced in accordance with the present invention.

### DETAILED DESCRIPTION OF THE INVENTION

The present invention is now illustrated in greater detail by way of the following detailed description which represents the best presently known mode of carrying out the invention. However, it should be understood that this description is not to be used to limit the present invention, but rather, is provided for the purpose of illustrating the general features of the invention.

As used herein, the term “filament” may refer to a strand, string, strip, material segment or the like that can be used in constructing the open carrier web assembly of the present invention. The materials that may be used in forming the open carrier web include nylon, polyethylene, silicone coated materials, UV cured materials, rubber, Teflon® and the like. Ideally, the type of material that is selected will have a suitable release property for the type of adhesive with which it is to come into contact. For example, a permanent pressure sensitive adhesive will likely require a material having a higher or greater release ability than a repositionable or removable adhesive.

The thickness of the filament or sting may also be dependent on the thickness of the adhesive. A thicker coating of adhesive say for example one ranging from 0.001 mil to about 5.0 mil coat weight or thickness of adhesive, with a more preferred exemplary embodiment ranging from about 0.001 mil to about 3.0 mil may require a filament or string having a thickness of about 1 mil to about 3 mils or a ratio of about 1:1 filament thickness to adhesive thickness so that the filament does not sink completely into the adhesive during processing. With adhesives that are not flowable due to thickness or type of adhesive a less thick filament may be used such as a 0.5 mil creating a ratio of about 1:2 filament thickness to adhesive thickness. Other permutations are possible.

The present invention may be particularly suitable for the production of prime label type pressure sensitive products as well as other higher end products that use high quality printing or may have a glossy appearance with the label. The term “prime label” as used herein refers to a label or other identification piece that may be used interchangeably with labels, such as tags, typically having a pattern of adhesive disposed on one side of a substrate and one or more graphical illustrations or depictions on the opposite side. Some level of textual messaging may also be provided on the face of the label. The adhesive is typically a pressure sensitive adhesive but may also include activatable adhesives such as thermally or moisture sensitive materials. However, it should be understood that all prime labels need not be provided with an adhesive.

Prime labels are further distinguished from other labels in the art in that such labels are known as having a high level of quality or value. The term prime label is often used to describe a type of label that is the highest grade marketed in a particular industry. Prime labels find application in a number of exemplary areas but have found wide range acceptance particularly in the area of consumer packaged goods (“CPG”) and other products for which the prime label is an effective means for communicating a specific message or for enhancing the image of the manufacturer or distributor or presenting the product as a high quality item. Prime labels are also used for business communications in that they can convey certain desirable criteria, image, brand recognition or information and can be used independently of a product, such as in connection with advertising a service opportunity or offering, or with other activities or undertakings, such as for example non-profit organizations.

Prime labels, particularly prime labels prepared in accordance with the present invention, may also contain printed messages, including personalized and/or variable information in addition to the graphical displays. The printed messages can be fixed or static, as will be explained herein, may be personalized or sequentially numbered or provided with other unique or special identifiers.

The term “patterns” as used herein refers to strips, lines, shapes, spots, dots, elements and discontinuous segments, as well as regular and irregular placement of such items. Patterns may also refer to combinations of the above-mentioned items such that one pattern may be a continuous strip; another, segmented elements; and a still further irregular placement of elements or the like. Any combination of patterns is possible depending on the need or application of the manufacturer or the end user. In addition, the pattern can be prepared in order to accommodate a particular theme, season, event, trade dress, graphics, alpha and numeric characters, and the like. Patterns are used in connection with the present invention to describe the placement of the label segments or ribbons applied to the web or individual prime labels positioned on the web in a particular pattern or arrangement. Pattern as defined herein also is used in connection with the adhesive that is applied to the continuous web as well as the open celled configuration that may be found in the carrier web.

As used herein, the term “business communication piece or document” refers to a substrate that, either alone or in combination with other documents, can convey a particular message or image or provide information about a particular product or service that is available from the provider of such pieces or documents. Business communication documents or pieces can include advertising, sales and marketing collateral and such other items used to convey information on written or imaged form sheets, brochures, presentation folders, informational sheets and combinations thereof.

The term “personalized information” refers to information that is printed or imaged onto a substrate, which is generally variable or unique and which may change from document to document or segment to segment so as to create a customized message or communication for each recipient. Examples of personalized information may include names, addresses, descriptions, plans, coding, numbering, promotional text, etc. that may have been acquired from the intended recipient through surveys, questionnaires or answers given to various inquiries generated in response to a request for goods or services.

The term “static or fixed” information refers to printed or imaged information that generally does not change from document to document or segment to segment and may include a general description or body of information about particular products, services, places, etc. that may be of interest to the intended recipient and represents a standard message that the manufacturing or supplier wishes to convey to an end user or customer of the offering.

The term “intermediate” as used herein refers to a product that undergoes one or more processing steps prior to the intermediate reaching a final condition, that of being ready for end use or application. The additional processing steps may include printing, imaging, folding, sealing, separating, cutting, perforating, scoring, adhering and the like. Typically, a product such as with the present invention is provided in an intermediate condition so that a user can add or manipulate the intermediate to create the final or desired end product, such as applying the prime label to a container, carton or the like. Thus, in accordance with the present invention, the intermediate segment, for example, could be subject to die cutting or additional printing, such as through ink jetting, over laminating, coating or embossment, and then applied to a container, carton, consumer package good or the like.

The term “sheets” or “segments” as used herein in connection with label segments refers to sheets, segments, ribbons, strips, pieces, parts, sections, subdivisions and combinations thereof. The sheet or segment provided as an example for the purposes of this specification can be an entire sheet such as 8½″×11″, 11″×14″, 19″×25″ and other known sheet sizes or may be segments, divisions, strips, etc. of such sheets. For example, a 19″×25″ sheet may be produced with five rows of labels, with each row having six labels, with each label having dimensions of approximately 3″×4″. For instance, in this example, each row may comprise an individual segment or sheet that may be used in practicing the present invention. It should, however, be understood that the invention is not to be so limited to the foregoing configuration that individual pieces or elements, regardless whether the piece or elements have a regular or irregular shape, may be used in connection with this process to produce the intermediate assembly that is described in this application.

An exemplary high resolution imaging device that is used in preparing the areas of the sheets that will become the prime label segments as well as the film, if the film is preprinted, used to cover the segments in accordance with the present invention includes an Indigo®, available from Hewlett Packard of Palo Alto, Calif. or Karat available from KBA of Williston, Vt. The present invention seeks to provide a prime label segment or intermediate that has a quality of at least about 150 or more lines per inch and preferably more than 300 lines per inch, which is approximately equal to about 2500 to 3500 dots per inch (“DPI”) in order to create a high quality image that is intended to be aesthetically appealing to the consumer.

An exemplary placer, feeder or insertion device that is used in the practice of the present invention is a Maverick® unit that is available from In-Line Automation of Minneapolis, Minn. The unit may use vacuum cylinders, belts or other suitable transfer means to transfer the individual segments to the web of material.

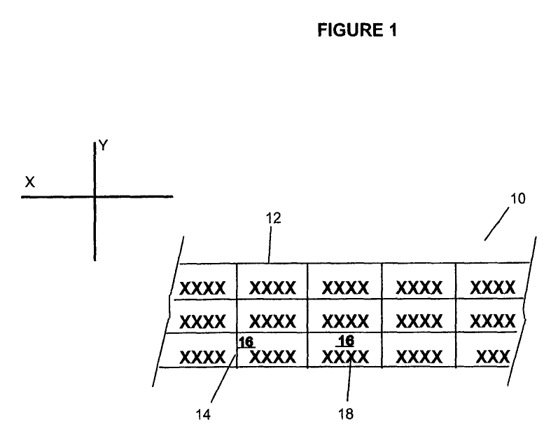

Reference is now directed to FIG. 1, which shows a view of an open celled carrier web generally depicted by numeral 10. The carrier web 10 is composed of a series of first filaments 12 that extend in a first direction along the “X” axis. A second set of filaments 14 is provided and bonded to the first set of filaments and extend in a second direction, in this FIG. 1 along the “Y” axis. As can be seen from the drawing the second set of filaments 14 generally appear perpendicular to the first set of filaments 12 forming a series of generally quadrate open celled areas 16. The carrier web 10 will be placed over an adhesive backed substrate or series of label or pressure sensitive intermediate segments such that the adhesive 18, which is represented in the FIGURE by a series of “XXXX” will be exposed.

Preferably, at least one set of the filaments 12 or 14, and likely both, will have a thickness that is sufficient to not be fully consumed by the thickness of the adhesive layer 18. That is, if a 2 mil thick layer of adhesive has been provided on a substrate, the thickness of the filament layer will be approximately 2 mils so that if the filaments are pressed into the adhesive, such as may occur during manufacture and subsequent handling of the product, at least a portion of the segments will still be above the surface of the adhesive layer, creating a ratio of about 1:1 filament thickness to adhesive thickness. In other arrangements, the filament thickness may be about half of the thickness of the adhesive if the adhesive is not particularly flowable such as may be the case with a removable or repositionable adhesive creating a supplemental ratio of about 1:2 filament thickness to adhesive thickness.

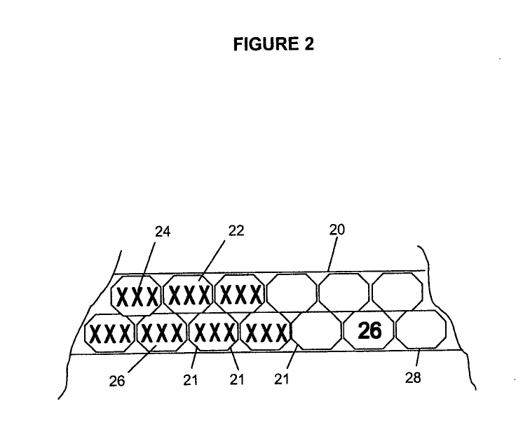

Turning now to FIG. 2 of the present invention, an alternate open celled web configuration is presented showing a non-quadrate pattern of open cells, in a honeycomb like arrangement. The edge 20 of the pressure sensitive laminate is shown to which the carrier web 21 has been applied, and as will be described. The carrier web 21 has a series of open cells 22 that are formed by bonding a number of segments 26 and 28 of filaments or strings. The filaments or strings are preferably woven into the configuration of the final web assembly before the carrier web is brought into contact with the pressure sensitive laminate. Alternatively, the web can be woven “in-line” that is by feeding the individual segments during the manufacturing process to form the carrier web for the pressure sensitive laminate.

The bonding of the filaments can occur by application of heat if the filaments are synthetic or may be fused by heat, twisting or weaving or by adhesive or other suitable affixing formulations such as an epoxy.

Each of the cells 22 enables the adhesive 24, illustrated by a “XXX” to be exposed to view. That is, as the cells are open, the adhesive remains exposed. Again, as described above, the filaments that make up the cells 22 will be sufficiently thick so that a top surface of the filament will be clear of the adhesive so that the pressure sensitive construction may be wound on to itself or otherwise collected for use. The filaments used in the practice of the present invention range for example from about 0.005 mils to about 5 mils.

While FIGS. 1 and 2 show exemplary quadrate and non-quadrate shapes in forming the open celled arrangement of the carrier webs, it should be understood that other cellular type arrangements are possible, such as triangular, circular, pentagonal, hexagonal, etc. Particular pre-determined patterns of cells that can be created may also be used in connection with specific adhesive types or thicknesses. For example, it may be desirable when using a flowable adhesive to have tighter or smaller cellular openings so as to preclude adhesive from oozing out of the cells and in contact with the processing apparatus or other surfaces. Such cells would likely have an inner dimension and be smaller than one eighth of an inch. Likewise, an adhesive which is less tacky or which is cured or more firm so it does not flow may use a more open cellular configuration in which each of the cells are larger, that is an inner dimension for example from one eighth of an inch to one half of one inch.

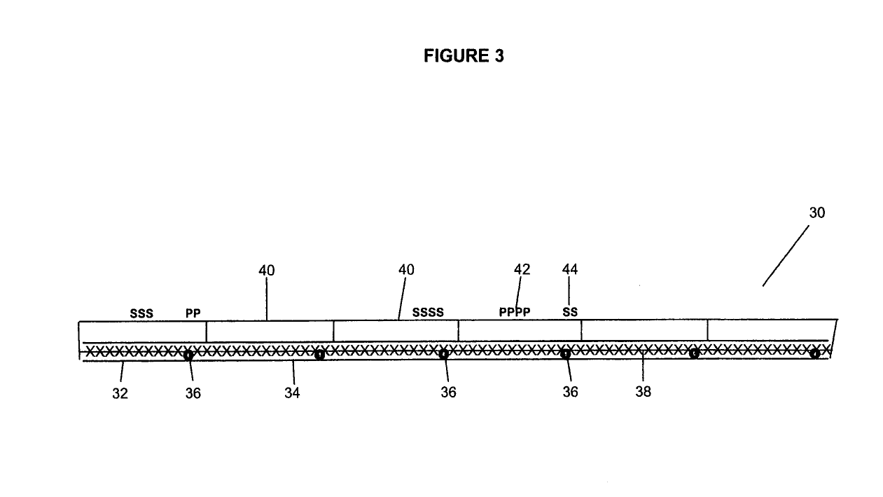

FIG. 3 presents a side view of an exemplary pressure sensitive product configuration produced in accordance with the present invention. The pressure sensitive product is generally referenced by numeral 30 and includes a carrier web 32 which is constructed from at least first and second strings or filaments 34 and 36 which are placed in two distinct directions from one another. The filaments 34 and 36, and as shown in the previous FIGS. 1 and 2, are spaced from one another, generally equally, so as to create a number of open cells through which a portion of the adhesive pattern is exposed. The adhesive in FIG. 3 is represented by numeral 38 and designated though the use of the character “x” and shown generally in a continuously occurring pattern. The filaments 34 and 36 are shown partially embedded or immersed in the adhesive layer 38 to illustrate that the filaments of the carrier web can then still provide sufficient release properties and prevent the adhesive from coming into contact with surfaces to which the adhesive might inadvertently adhere. That is, the thickness of the filaments is sufficient to extend up and beyond the thickness or surface of the adhesive in the event the adhesive is flowable or soft which would permit the carrier web to partially sink into the adhesive pattern on the pressure sensitive product.

FIG. 3 also shows a series of label intermediates 40 disposed over the pattern of adhesive 38. The label intermediates are shown in a substantial edge to edge alignment with one another. However, it should be understood that the label intermediates may be positioned on the carrier web with a slight overlapping or shingling arrangement. The area of overlap, if one occurs in operation of the system, is less than one inch, more preferably less than one half of one inch and still more preferably about one eighth of an inch and yet still more preferably less than about one thirty second of an inch to about one sixty fourth of an inch. The area of the overlap provides a border, margin or matrix for each label that surrounds the area that will become the prime label. The area of the matrix or margin ranges between about one fourth of an inch to about one eight of an inch and more preferably about one thirty second of an inch to about one sixty fourth of an inch to compensate for the possible overlap between successive label segments or sheets. That is, no area of the label intermediate will encroach on another label segment and the overlap, if present, is only represented by the area of the margin or matrix. While the invention has been described in the present embodiment as having an area of overlap, it should be understood that the invention might be practiced where the edges of successive labels substantially abut one another or alternatively, there may be a slight space or gap between successive labels.

FIG. 3 is also used to illustrate that the label segments may be provided with personalized indicia, here represented by the designation “P” and the numeral 42 as well as static or fixed indicia, here represented by the designation “S” and the numeral 44. As the label segments are previously prepared, as will be herein described, the system can be used to create highly personalized pressure sensitive products for the end user customer.

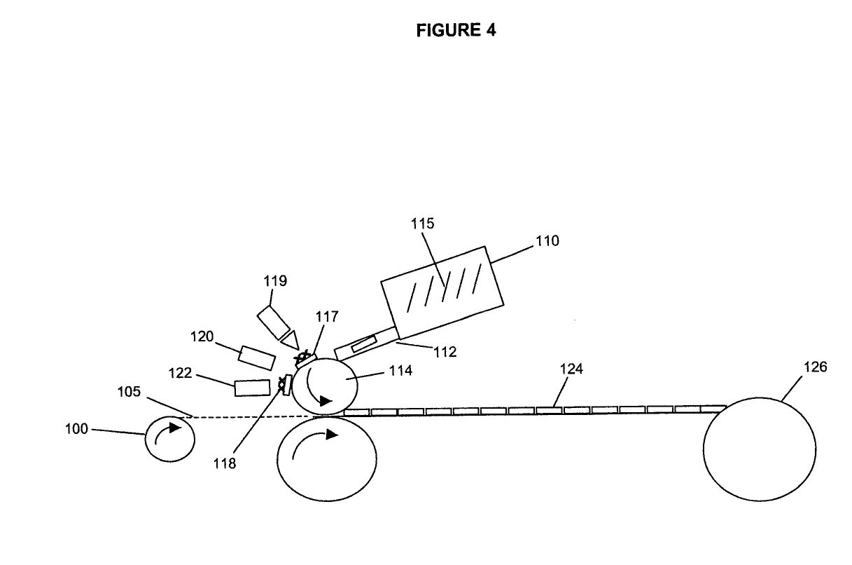

Turning now to FIG. 4 which represents a schematic of the apparatus used in carrying out the present invention. For the purposes of this discussion, it will be assumed that the open celled carrier web has been preformed and is provided from a source 100. It should however be understood that the web may be formed in-line as part of the manufacturing process. In this latter embodiment, individual filaments are fed from one or more sources and then are affixed to the label intermediates through the use of adhesive as will herein be described.

The carrier web 105 is advanced in a machined direction to a position where individual label intermediate segments will be placed on the web. The label intermediates are preprinted by a high quality imaging device as has already been described. The label intermediates are printed in a sheet form and then the sheets are cut to create the individual segments that are used in the preparation of the present pressure sensitive assembly. For additional information in connection with the printing and forming process of intermediate pressure sensitive web assemblies, see Ser. No. 11/135,481 filed May 23, 2005, Ser. No. 11/135,179 filed May 23, 2005 and Ser. No. 11/135,131 filed May 23, 2005 the disclosures of each of which including that found in the claims is incorporated herein by reference and each of which are owned by a common assignee with that of the instant application.

Once the individual segments are printed, generally with high quality graphics and textual information, including personalized and static information, the segments 115 are placed into a hopper 110 of a mechanical placer mechanism 112 that will be used to place the individual segments in a sequential and regular fashion on a carrier web of material. The individual segments 117 are then placed on a drum, for example a vacuum drum 114 and rotated to an adhesive application station, e.g. a slot die applicator, 119 where a pattern of adhesive 118 is applied to one face of each of the label segments 117. The segments with adhesive are then passed to a UV curing station 120 and then to a laser die cutting station 122 which is used to die cut the prime label portion from the matrix portion of each of the label segments. The segments are then placed adhesive side down into contact with the carrier web as shown at 124. The pressure sensitive web is then collected at station 126 for example in a continuous format, although other formats such as fan folding are of course possible.

It will thus be seen according to the present invention a highly advantageous filament based carrier system for pressure sensitive products has been provided. While the invention has been described in connection with what is presently considered to be the most practical and preferred embodiment, it will be apparent to those of ordinary skill in the art that the invention is not to be limited to the disclosed embodiment, and that many modifications and equivalent arrangements may be made thereof within the scope of the invention, which scope is to be accorded the broadest interpretation of the appended claims so as to encompass all equivalent structures and products.

The inventors hereby state their intent to rely on the Doctrine of Equivalents to determine and assess the reasonably fair scope of their invention as it pertains to any apparatus, system, method or article not materially departing from but outside the literal scope of the invention as set out in the following claims.

1. A method of releasably transporting adhesive-backed labels on a moving web, comprising the steps of:
a) providing first mutually parallel filaments in a first direction;
b) providing second mutually parallel filaments extending across said first filaments in a second direction at an angle to said first direction;
c) bonding said first and second filaments together to form an open-celled movable carrier web for carrying adhesive-backed labels;
d) coating said filaments with a release agent;
e) providing labels each including a printed substrate backed with a layer of adhesive whose thickness is from about 1 to about 2 times the diameter of said filaments; and
f) depositing said labels onto said open-celled carrier web with said adhesive against said web;
g) so that said adhesive is exposed through the open cells of said carrier web but is held spaced by said filaments from any surface over which said web moves.

2. The method of claim 1, in which said adhesive is flowable and the ratio of adhesive thickness to filament diameter is about 1:1.

3. The method of claim 1, in which said adhesive in non-flowable and the ratio of adhesive thickness to filament diameter is about 2:1.

4. The method of claim 1, in which said parallel filaments are spaced about ⅛ to ½ inch from each other, and the filament diameter is about 0.5 mil to 3 mil.

5. The method of claim 1, in which said filaments are strings.
